(19) United States
(12) Patent Application Publication
(10) Pub. No.: US 2026/0303425 A1
(43) Pub. Date: Oct. 1, 2026

(54) METHOD OF CREATING EMBEDDED COMPONENTS ON AN ANTENNA SUBSTRATE AND ANTENNA APPARATUS FORMED WITH SAME

(71) Applicant: VIASAT, INC., CARLSBAD, CA (US)

(72) Inventor: David R. Saunders, Scottsdale, AZ (US)

(21) Appl. No.: 19/490,993

(22) PCT Filed: Jun. 8, 2023
(86) PCT No.: PCT/US2023/024884

§ 371 Date: Dec. 8, 2025

(51) Int. Cl. H04L 27/26; H04L 5/00; H04L 27/00

(52) U.S. Cl. CPC H04L 27/26025; H04L 5/0023; H04L 27/0008; H04L 27/2646; H04L 27/2662; H04L 27/2675

(57) ABSTRACT

A synchronization method involves operations at a timing source and at distant timing circuits each communicatively coupled to the timing source. At the timing source, a reference signal having a reference frequency is generated; a multi-tone waveform is generated; and the reference signal and the waveform are combined to generate a synchronization signal having first temporal portions including the reference signal without the waveform, interspersed with second temporal portions including the waveform. The synchronization signal is transmitted to the timing circuits over each of plural signal paths having different respective propagation delays. Each of the timing circuits determines a phase difference between the received tones to determine a propagation delay of the connected signal path. Each reference signal is individually delayed at the timing circuits based at least on the propagation delay such that the timing circuits provide phase aligned output reference signals.

### TECHNICAL FIELD

This disclosure relates generally to synchronization methods, and more particularly to synchronization methods for electronically steerable antenna array systems having physically distributed antenna assemblies.

### DISCUSSION OF RELATED ART

The problem of providing synchronized reference signals at different physical locations may arise in various communication systems. One example occurs in electronically steerable antenna arrays, e.g., phased arrays, in which digital beamforming is utilized to form transmit and/or receive beams.

Traditional (pure analog-configured) antenna arrays with N antenna elements form a transmit beam by routing an input RF transmit signal through a combiner/divider network (“distribution network”) that divides the transmit signal into N “element signals”. In arrays with distributed transceivers, the N element signals are typically amplified and/or phase shifted in an RF front end between the antenna elements and the distribution network. In the receive path, a composite receive signal is obtained in the reverse process by combining N element signals received by the N antenna elements using the same or different combiner/divider network. The distribution network often requires precise calibration such that all the N propagation paths from the RF input port to the N antenna elements on transmit, and between the N antenna elements and the RF output port on receive, have a calibrated insertion phase (typically the same insertion phase). However, at microwave and millimeter-wave frequencies, such calibration becomes costly and complex due to the small wavelengths involved.

Accordingly, in recent years, attempts have been made to provide antenna arrays composed of antenna element assemblies or antenna sub-array assemblies that are not RF coupled to one another by a distribution network. Each assembly implements digital beamforming and may have its own oscillator for generating an individual transmit signal and/or an individual receive signal. On transmit, to generate a coherent beam collectively from the assemblies, the individual transmission signals need to be synchronized in time and frequency. In the receive path, the receive signal needs to be sampled within each of the assemblies to generate a digital output stream, and the sampling needs to be synchronized between the assemblies such that sampled outputs can be combined by a processor to obtain a composite receive signal. However, combining received signals from physically separated receivers (and likewise, far-field combining of transmitted signals from physically separated transmitters) requires frequency/phase coherency and time alignment of the physically separated units, which is difficult to achieve.

### SUMMARY

In an aspect of the present disclosure, a synchronization method involves operations at a timing source and at distant timing circuits each communicatively coupled to the timing source. At the timing source: a reference signal having a reference frequency is generated; a waveform having a plurality of tones is generated; and the reference signal and the waveform are combined to generate a synchronization signal having first temporal portions including the reference signal without the waveform, interspersed with second temporal portions with the waveform. The synchronization signal is transmitted over a plurality of signal paths having different respective propagation delays to a plurality of timing circuits, respectively. A first timing circuit determines a phase difference between at least two of the received tones and delays the reference signal by a delay based at least in part on the phase difference, so as to provide a first output reference signal phase aligned with a second output reference signal provided at a second timing circuit.

The plurality of tones of the waveform may be subcarriers of an orthogonal frequency division multiplexing (OFDM) signal that modulates the reference signal. The subcarriers may each be digitally modulated with a known pseudo-noise (PN) code to facilitate detection of the waveform at the timing circuits.

In another aspect, a synchronization system includes a timing source including: an oscillator to generate a reference signal (Sref) having a reference frequency (Fref); one or more processors to generate a digital signal constructable from a plurality of tones; a digital to analog converter (DAC) to convert the digital signal to a waveform; a combiner to combine the reference signal with the waveform to generate a synchronization signal having first temporal portions including the reference signal without the waveform, interspersed with second temporal portions with the waveform. The system further includes N timing circuits; and N signal paths between the timing source and the N timing circuits, respectively, the N signal paths having different respective propagation delays. The timing source transmits the synchronization signal over the N signal paths to the N timing circuits, and phase alignment of output reference signals may be attained in the same way as outlined in the above-summarized method.

In another aspect, an antenna system includes a digital beamforming (DBF) processor, and a plurality of subassemblies, each RF coupled to one or more antenna elements. The antenna system further includes the above-summarized synchronization system, where each subassembly includes a respective one of the timing circuits. Each of the plurality of subassemblies uses one of the of the output reference signals to generate a transmit path signal and/or receive a receive path signal in a coherent manner with other ones of the subassemblies, to collectively form a transmit and/or receive beam through digital beamforming controlled by the digital beamforming processor.

### BRIEF DESCRIPTION OF THE DRAWINGS

The above and other aspects and features of the disclosed technology will become more apparent from the following detailed description, taken in conjunction with the accompanying drawings in which like reference characters indicate like elements or features. Various elements of the same or similar type may be distinguished by annexing the reference label with an underscore/dash and second label that distinguishes among the same/similar elements (e.g., _1, _2), or directly annexing the reference label with a second label. However, if a given description uses only the first reference label, it is applicable to any one of the same/similar elements having the same first reference label irrespective of the second label. Elements and features may not be drawn to scale in the drawings.

FIG. 1 is a block diagram of a time and frequency synchronization system according to an embodiment.

FIG. 2 illustrates an example synchronization signal transmitted from a timing source to distant timing units of the synchronization system.

FIG. 3A depicts a simplified frequency spectrum of a waveform portion of the synchronization signal according to an example.

FIG. 3B depicts a simulated example of a frequency spectrum of a waveform portion of the synchronization signal with modulated OFDM subcarriers.

FIG. 4 is a flow diagram of a synchronization method according to an embodiment.

FIG. 5 is a flow diagram of a synchronization method involving exchange of time of day (ToD) measurements according to an embodiment.

FIG. 6 is a timing diagram illustrating example signals and concepts in the methods of FIGS. 4 and 5.

FIG. 7A is a block diagram depicting an example timing source and timing circuit in the synchronization system of FIG. 1.

FIG. 7B is a schematic diagram of an example combiner in a timing source of FIG. 7A.

FIG. 8 schematically illustrates an antenna system that incorporates the synchronization system of FIG. 1.

### DETAILED DESCRIPTION OF EMBODIMENTS

The following description, with reference to the accompanying drawings, is provided to assist in a comprehensive understanding of certain exemplary embodiments of the technology disclosed herein for illustrative purposes. The description includes various specific details to assist a person of ordinary skill in the art with understanding the technology, but these details are to be regarded as merely illustrative. For the purposes of simplicity and clarity, descriptions of well-known functions and constructions may be omitted when their inclusion may obscure appreciation of the technology by a person of ordinary skill in the art.

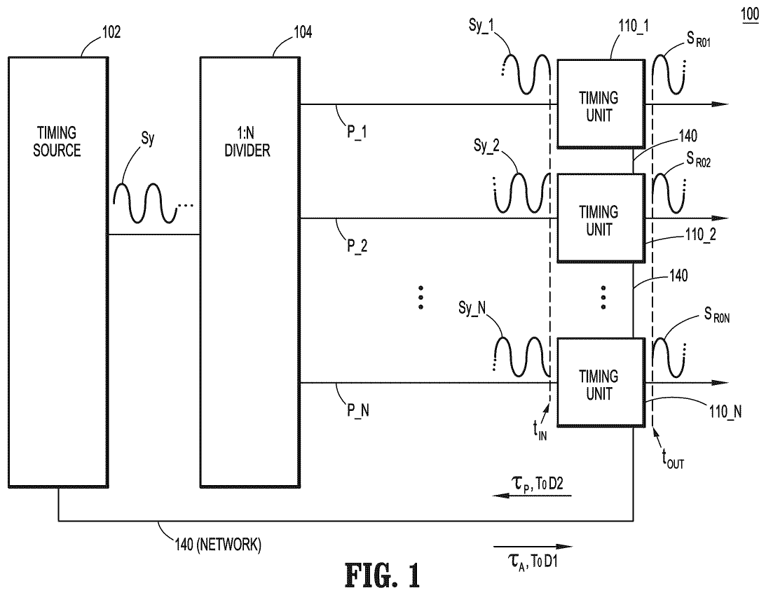

FIG. 1 is a block diagram of a time and frequency synchronization system, 100, according to an embodiment. Synchronization system 100 includes a timing source 102, a 1:N divider (herein, N=2 or more) 104; signal paths P_1 to P_N, timing units (interchangeably herein, “timing circuits”) 110_1 to 110_N, and a communication network (or links) 140, e.g., a wired packet network or independent links. Timing units 110 may each be disposed in a respective physically distributed assembly, such as a modularized subarray assembly or an antenna element assembly including a transceiver and modem of a phased array antenna system. A function of timing units 110_1 to 110_N may be to provide synchronized output reference signals S_{RO1} to S_{RON}. These reference signals S_{RO1} to S_{RON} may be used for synchronized sampling of radio frequency (RF) signals in receive and/or transmit paths to facilitate digital beamforming. Output reference signals S_{RO1} to S_{RON} may also be upconverted to produce synchronized transmit signals that collectively form a transmit beam.

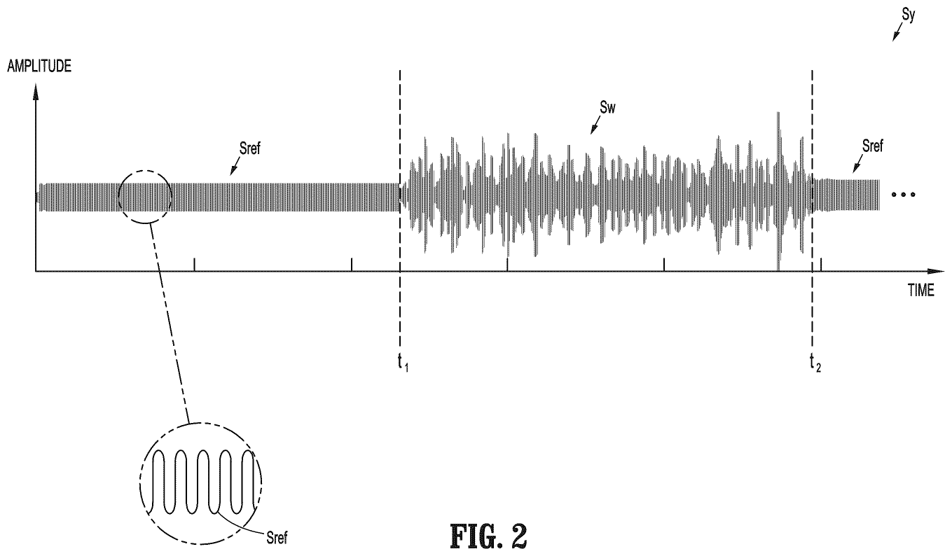

Timing source 102 outputs a synchronization signal Sy including first temporal portions (discussed below) with a reference signal Sref having a reference frequency Fref. Signal Sy is divided by 1:N divider 104 into N path signals Sy_1 to Sy_N, which are applied as inputs to signal paths P_1 to P_N. Signal paths P_1 to P_N may vary in length and/or characteristics such that each of the signal paths has a different insertion phase (“propagation phase”). As a result, signals Sy_1 to Sy_N at the outputs of signal paths P_1 to P_N may arrive at the timing units 110 at different times TIN and unsynchronized, i.e., with different instantaneous phases. Each timing unit 110_i (herein, i=any of 1 to N) may be configured to delay the respective signal Sy_i received or applied thereto by a delay sufficient to provide an output signal S_{ROi} that is phase coherent with the other output signals S_{RO} from the other timing units 110. Briefly, this may be accomplished by including, within second temporal portions of signal Sy, a multi-tone waveform Sw (exemplified in FIG. 2). One example of waveform Sw is a signal formed with plural sub-carriers of an OFDM signal generated using Sref as a carrier. Each timing circuit 110_i may compare the phases of at least two tones of the waveform to determine a phase difference between the tones. From the phase difference(s), a propagation delay τ_{P} over the signal path P_i can be determined. The difference in the propagation delays among the signal paths P_1 to P_N may then be determined, for example, by the timing source 102. With knowledge of the different propagation delays, individual delays τ_{A} to be applied to the respective timing units 110 can be determined for achieving synchronization among the output reference signals S_{RO}. The phase of the reference signal Sref portion of Sy may then be adjusted corresponding to the determined delay for that timing unit. Thus, the phase of Sref may be adjusted based at least in part on the phase difference, so as to provide the reference output signal S_{RO} (e.g., a delayed version of Sref) phase aligned with those of the other timing units.

Messages may be transferred between timing source 102 and timing units 110 over network 140 to facilitate the synchronization process. For instance, timing source 102 may transmit a message to each of the timing units 110 Indicating an upcoming global time-of-day, ToD1 at which the waveform will be transmitted. Each of the timing units 110 may determine a local time of day, ToD2, measured at a time point of detecting reception of the waveform. Each may then report the determined ToD2 or a ToD difference between ToD1 and ToD2 to timing source 102. Based on the ToD differences and the propagation delays τ_{P}, timing source 102 may determine the respective delays τ_{A} for timing units 110_1 to 110_N to be applied to synchronize the output signals S_{RO1} to S_{RON} to one another.

With the approach of the present embodiments, signal paths P_1 to P_N may be embodied as low cost, easy to connect and arrange wired paths such as Ethernet cables, optical fibers, coaxial cables, twisted pairs, and so forth, that are easy to arrange and connect and do not require insertion phase calibration. Further, because the delay adjustment process by the timing units may be dynamic through use of periodic phase measurements and adjustments, performance objectives may be realized over a range of environmental conditions, e.g., varying temperature and humidity, that may cause variation in insertion phase of the signal paths. As a result, a communication/antenna system that incorporates synchronization system 100 may be manufactured at a lower cost and may achieve performance objectives not otherwise realizable. As an example, the reference signal frequency Fref may be on the order of 100 MHZ whereas a final transmit signal or an input receive signal to be sampled may be in the range of 10× to 1000× higher than Fref. In one application, the present embodiments allow a digital beamforming system to be configured, using the phase aligned output reference signals S_{RO1} to S_{RON}, to form transmit/receive beams at the higher frequencies without the need for a calibrated combiner/divider.

FIG. 2 illustrates an example synchronization signal Sy transmitted from timing source 102 to distant timing units 110 of the synchronization system 100. Signal Sy may be a composite signal having “first temporal portions” with just reference signal Sref (a tonal signal at frequency Fref) interspersed with “second temporal portions” having a waveform signal (“waveform”) Sw, where waveform Sw is a multi-tone signal. In the example of FIG. 2, waveform Sw is an orthogonal frequency division multiplexing (OFDM) signal with phase shift keying (PSK) modulated subcarriers collectively representing a PN code. Only one second temporal portion is shown in FIG. 2, between times t1 and t2, and two first temporal portions are depicted, one just prior to time t1 and one just after time t2, though others may exist in the signal Sy. The second temporal portions may have durations at least one order of magnitude less than the first temporal portions. In one example, Fref is about 100 MHz and the waveform Sw period (t2−t1) is about 2.5 us. Waveform Sw can be designed with much higher peak-to-average power (e.g., at least 10× higher) than that of reference signal Sref so that the associated signal processing to detect and analyze waveform Sw can be idle most of the time to conserve power.

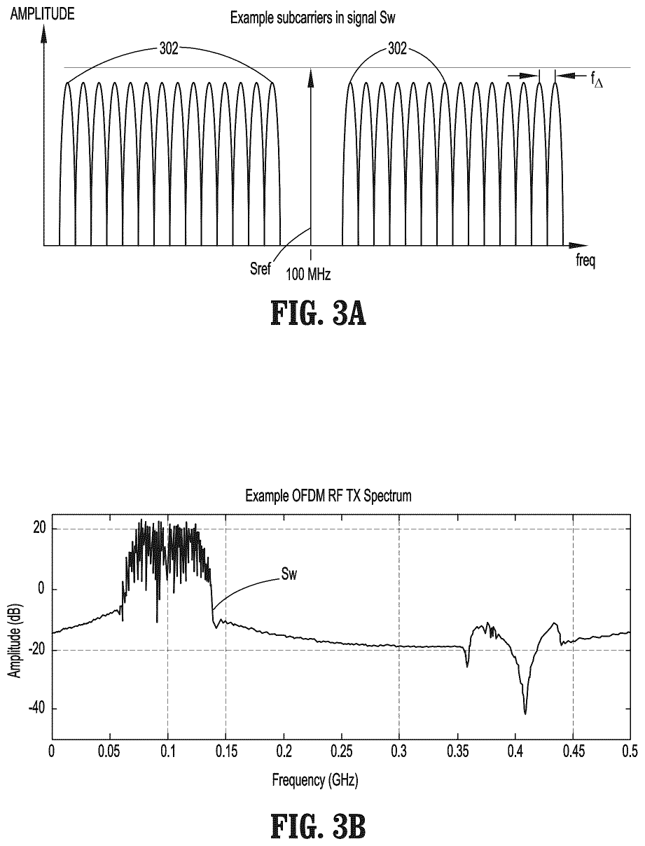

FIG. 3A depicts a simplified frequency spectrum of the waveform Sw of synchronization signal Sy according to an example. In this example, waveform Sw includes reference (carrier) signal Sref at frequency Fref=100 MHZ, which is OFDM modulated to produce subcarriers 302 (shown unmodulated in FIG. 3A) with a subcarrier spacing fa. One or more central subcarriers on each side are turned off to prevent creating phase disturbances close to reference signal Sref. Thus, the closest subcarrier 302 may be at least 2f_{Δ} away from reference signal Sref. In FIG. 3A, two central subcarriers on each side are turned off.

FIG. 3B depicts a simulated example of a frequency spectrum of waveform Sw of synchronization signal Sy with modulated OFDM subcarriers. Here, the subcarriers of waveform Sw are binary phase shift keying (BPSK) modulated with a low correlation sidelobe code, e.g., a pseudo-noise (PN) code known at the timing units 110, which in this example is the Chu sequence. The modulation of the subcarriers with a known code facilitates the detection of waveform Sw by the timing units 110. FIG. 3B shows simulation results of an example with Sref at 100 MHz, 128 subcarriers spaced 0.5 MHz apart, symbol period of 2 μs, and the central eight subcarriers turned off to prevent phase disturbances close to Sref. When at least 100 subcarriers are included, a 50 Mbps code rate may be feasible.

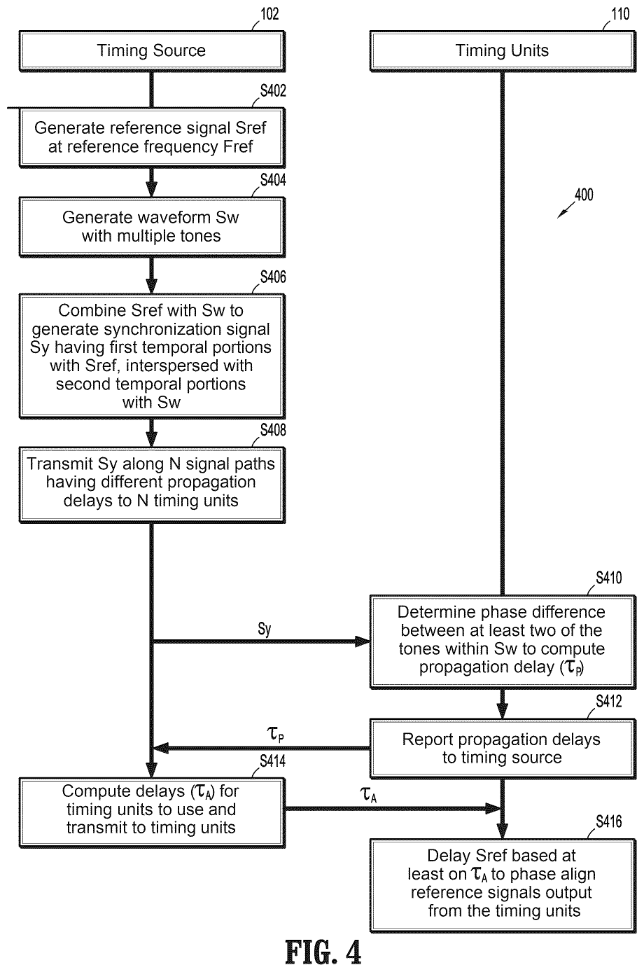

FIG. 4 is a flow diagram of a synchronization method, 400, performed by synchronization system 100 according to an embodiment. Note that the order of operations of method 400, as well as those of other flow diagram(s) herein, may differ as desired in other embodiments. Additionally, operations shown may be excluded and operations not shown may be added. With method 400, timing source 102 generates a tonal reference signal Sref at frequency Fref (operation S402). Timing source 102 may also generate multi-tone waveform Sw, e.g., through OFDM modulation that uses Sref (S404). Reference signal Sref may then be combined with waveform Sw to generate a synchronization signal Sy having first temporal portions with just Sref, alternating or otherwise interspersed with second temporal portions with waveform Sw (S406). Synchronization signal Sy may then be transmitted along N signal paths P_1 to P_N having different propagation delays, to N timing units 110_1 to 110_N, respectively (S408). It is noted here that each signal path P_i may be assumed to include a propagation distance from a circuit point of the signal Sy creation within timing source 102, through 1:N divider 104, to the input of the signal path P_i shown in FIG. 1. In other words, each of the signal paths P_1 to P_N in FIG. 1 may be assumed to include the propagation delay through 1:N divider 104 and any relevant path length within timing source 102.

Each timing unit 110_i may compute a propagation delay τ_{P} for the respective signal path P_i by first determining a phase difference between at least two of the tones within waveform Sw (S410). Alternatively, the phase differences are reported to timing source 102, and timing source 102 performs the propagation delay calculation, as introduced above. Digital signal processing may be used to extract “delay” from the received waveform in the following manner. The waveform Sw (represented below as w(t)) may be modeled as a sum of sinusoids according to the following equation:

$$w ( t ) = {\sum }_{i = 0}^{i = M - 1} cos [ 2 π {f}_{i} ( t + τ ) + {θ}_{i} ] , \qquad ( Eqn . 1 )$$

where time t runs from 0 to Ts, the waveform period (e.g., (t2−t1) in FIG. 2); the summation index value i represents any of M subcarriers of waveform Sw; ƒᵢ is the frequency of subcarrier i; τ is propagation delay τ_{P}; and is θ_{Δ} is subcarrier initial phase at t+τ=0.

If the initial phase of each subcarrier is set to zero and the M subcarriers are equally spaced in frequency by ƒ_{Δ}, the phase difference φ_{Δ} between adjacent subcarriers can be written as:

$${φ}_{Δ} = 2 π {f}_{i + 1} ( t + τ ) - 2 π {f}_{i} ( t + τ ) = 2 π {f}_{i + 1} t + 2 π {f}_{i + 1} τ - 2 π {f}_{i} t + 2 π {f}_{i} τ . \qquad ( Eqn . 2 )$$

$${φ}_{Δ} = 2 π ( {f}_{i + 1} - {f}_{i} ) t + 2 π ( {f}_{i + 1} - {f}_{i} ) τ = 2 π {f}_{Δ} t + 2 π {f}_{Δ} τ . \qquad ( Eqn . 3 )$$

The subcarrier frequencies are known at the timing units 110, so the propagation delay τ_{P} can be calculated by performing a Fast Fourier Transform (FFT) of the received waveform S_{W} and comparing the phase differences between subcarriers. It is noted here that while a minimum of a single phase difference between two subcarriers may be sufficient to compute τ_{P}, higher accuracy is obtainable using two or more phase differences between two or more subcarriers, respectively, through averaging.

The timing units 110 report the respective propagation delays UP to timing source 102 over network 140 (S412). Timing source 102 then computes, based at least in part on the received delays τ_{P}, respective delays τ_{A} to be applied to the reference signal Sref received by each of the N timing units 110_1 to 110_N (S414). Alternatively, delays τ_{A} are transmitted to and applied by (N−1) timing units 110, and one of the timing units 110 is used as a reference (delay applied=0). Each timing circuit 110 then delays Sref based on the received delay τ_{A} to phase align all output reference signals S_{RO1}−S_{RON} (S416). In some embodiments, the delays τ_{A} may be determined and applied by respective timing units 110.

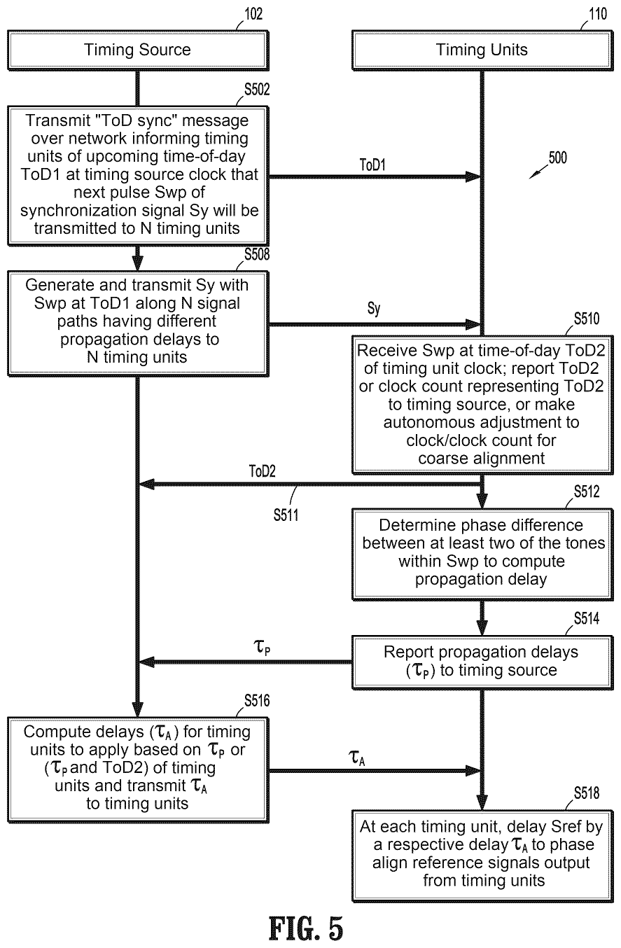

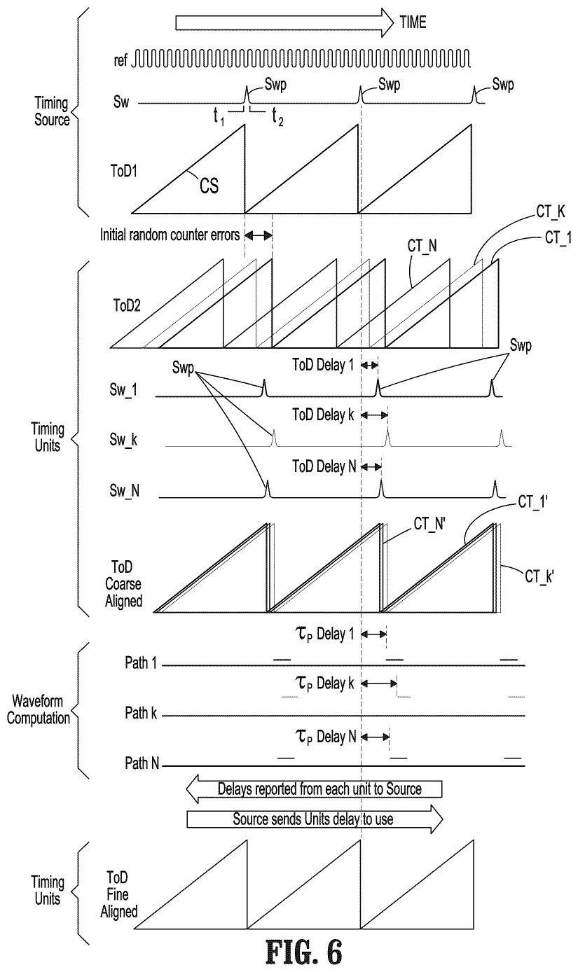

FIG. 5 is a flow diagram of a synchronization method 500, which involves exchanging of time-of-day (ToD) measurements to attain ToD synchronization according to an embodiment. Method 500 will be discussed hereafter in connection with the example signals shown in FIG. 6. In some applications it is desirable or necessary for each timing unit 110 to include a ToD counter that is synchronized with the ToD counters of the other timing units. This may facilitate achieving a desired outcome of synchronized sampling of signals for both receive and transmit operations. For an antenna system with physically distributed assemblies, with each assembly having a timing unit 110, such ToD synchronization in conjunction with the synchronization of output reference signals S_{RO1} to S_{RON} allows each assembly to sample a receive signal at precisely the same time, enabling coherent reception by the assemblies and proper formation of a receive beam. Analogous synchronized sampling may occur for transmit operations to generate coherent transmit signals.

The timing units 110 may have respective ToD counters that are initially unsynchronized with one another. Thus, as shown in FIG. 6, the ToD counters may initially output, upon power-up initialization, different counts CT_1 . . . . CT_N (representing the time-of-day), resulting in local ToD outputs that are initially unsynchronized. With method 500, ToD values measured at the time that an instance of waveform Sw is detected, as well as computed propagation delay values or phase difference values, may be reported by the timing units 110 to timing source 102. Alternatively, autonomous adjustments of local clocks are made at the timing units, and only propagation delays are reported to the timing source, as discussed below. This allows timing source 102 to calculate respective delays for the timing units 110 to apply to achieve both ToD synchronization and reference signal synchronization.

Accordingly, in operation S502, timing source 102 may transmit a “ToD sync” message over network 140 informing each of timing units 110 of an upcoming time-of-day ToD1, to be measured at timing source 102's clock, that the next pulsed waveform Sw of the synchronization signal Sy will be transmitted to timing units 110. For example, as shown in FIG. 2, the time period (t1 to t2) may be considered a period of one instance of waveform Sw (“one pulse” of signal Sy); and prior to time t1, timing source 102 may transmit the ToD sync message indicating ToD1=t1. As shown in FIG. 6, the waveform Sw may be a signal with periodic pulses Swp each having the same or similar time varying amplitude as in FIG. 2 (each pulse having a duration of (t2−t1)). Timing source 102 may have a counter that increments a count CS representing a “global” time-of-day. The count CS may be incremented at each cycle of Sref, i.e., at a frequency of Fref. The count may be reset at the time t1 that the next pulse Swp is transmitted.

Timing source 102 may generate synchronization signal Sy with the next pulse Swp of waveform Sw beginning at a time ToD1 (=t1 shown in FIG. 6) and transmit the same to timing units 110 (S508). To this end, signal Sy may be generated in the same way as described above for operations S402 to S408 of FIG. 4. Each timing unit 110_i may receive signal Sy (including Sw), detect the next waveform pulse Swp thereof, and determine a local time-of-day, ToD2, that it was received (S520). In some embodiments, each timing unit reports the determined ToD2 to the timing source 102 (as indicated by the return arrow S511). In other embodiments, each timing unit 110_i makes an autonomous adjustment to its clock or clock count, with the aim of achieving a coarse alignment of local clocks among all the timing units 110_1 to 110_N. The local time-of-day ToD2 of timing unit 110_i may be represented by a clock count of a ToD timer running at timing unit 110_i, which may have the same characteristics as the counter in timing source 102.

For instance, as illustrated in FIG. 6, timing units 110_1, 110_k, and 110_N may have counters that initially output respective counts CT_1, CT_k and CT_N that differ significantly due to initial random counter errors, for example, upon power-up initialization. Upon detecting the next Swp pulse (following receipt of the ToD sync message), each of the timing units may have a different count that is due to the initial random counter errors. Thus, each timing unit 110 may output a significantly different ToD2 when the expected Swp pulse is detected. As mentioned above, in some embodiments, each timing unit 110 reports the measured ToD2 to timing source 102. In this case, timing source 102 may then compute a ToD-based delay to be applied by the respective timing units 110 to arrive at a coarse alignment of the ToD counters. (In FIG. 5, the ToD delay to be applied may be sent in a separate transmission, or as part of the τ_{A} transmission between S516 and S518, discussed below.)

In other embodiments, at S510, each timing unit 110 makes an autonomous adjustment to its count based on the difference (ToD2−ToD1), where ToD2 is the locally measured time when the expected Swp pulse is detected. The individual count adjustments result in a coarse alignment among the ToD counters. This is illustrated in FIG. 6 for either of the above two embodiments. Differing delays ToD Delay 1, ToD Delay k . . . ToD Delay N at the timing units 110, each referenced to the locally determined start of Swp, are due to the random counter errors. After an offset adjustment (based on a command from timing source 102 or autonomously made) due to the differing ToD2's, a coarse alignment of the counters is made, resulting in the counters outputting closer aligned counts CT-1′, CT-k′ and CT-N′. This coarse alignment does not take into account the differing propagation delays, which are typically significantly smaller than the initial random timing errors.

Now, because of the differing propagation delays over paths P_1 to P_N, even if there were no initial random counter errors at each of the timing unit counters, the measured ToD2 would differ at the various timing units 110_1 to 110_N. The differing propagation delays are exemplified in FIG. 6 as τ_{P} Delay 1, τ_{P} Delay k . . . τ_{P} Delay N. As illustrated in FIG. 6, a fine adjustment to the ToDs can then be made following a waveform computation (FFT analysis) of the received pulse Swp to compute the differing propagation delays over signal paths P_1 to P_N.

Accordingly, each timing unit 110 may determine a phase difference between at least two of the tones within waveform pulse Swp to compute a propagation delay of signal path P_i (S512) in the same manner as described above for method 400. The propagation delays τ_{P} may then be reported to timing source 102 (S514). Timing source 102 may then compute respective delays τ_{A} to be applied by timing units 110 and transmit the same to the timing units (S516). Here, in some embodiments, delays τ_{A} are computed based on both the propagation delays τ_{P} and the differences (ToD2−ToD1) between each measured local time-of-day ToD2 and the global time-of-day ToD1. In other embodiments in which the timing units 110 make their own autonomous adjustments to ToD as discussed above, the delays τ_{A} to be applied may be computed based just on the propagation delays τ_{P}.

Each timing unit 110 may then delay the input reference signal Sref that it receives by the respective delay τ_{A} sent to it by timing source 102 to phase align the output reference signals S_{RO1} to S_{RON} to one another (S518).

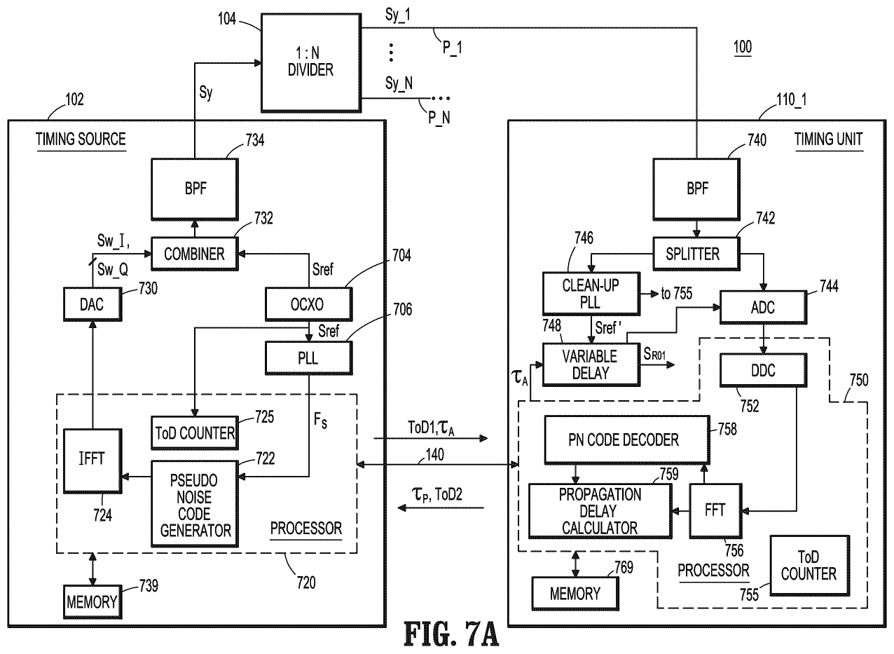

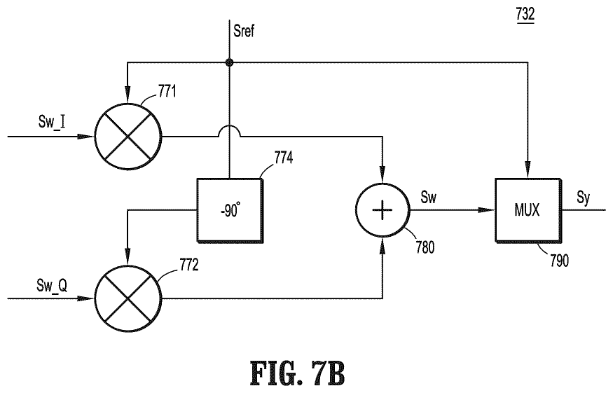

FIG. 7A is a block diagram depicting an example timing source 102 and timing unit 110_i in the synchronization system of FIG. 1. Timing source 102 includes both a high stability oscillator to create reference signal Sref and the digital signal processing to create the OFDM timing waveform Sw that is phase coherent with Sref, both of which are sent as portions of synchronization signal Sy through the exact same path P_i to a respective timing unit 110_i. To this end, timing source 102 may include a high stability oscillator 704 (e.g., an oven controlled crystal oscillator (OCXO)), a phase locked loop (PLL) 722, one or more processors 720 (hereafter, just “processor 720”), a digital to analog converter (DAC) 730, memory 739, a combiner 732, and a bandpass filter (BPF) 734. Processor 720 may include a pseudo-noise (PN) code generator 722, an Inverse Fast Fourier Transform (IFFT) engine 724, and a time-of-day (ToD) counter 725. Oscillator 704 generates reference signal Sref at frequency Fref, which may be applied to PLL 706, ToD counter 725, and combiner 732. ToD counter 725 may increment its count with each cycle (period) of signal Sref.

PLL 706 may convert signal Sref to a clock signal Fs, which is used by PN code generator 722 as a timing reference to generate a low correlation sidelobe code such as the Chu sequence. The code is applied to IFFT engine 724, which may generate a digital OFDM signal, e.g., a time varying complex sinusoid representing the code. The complex sinusoid may be represented by two output streams, an in-phase (I) signal stream and a quadrature phase (Q) signal stream. The digital OFDM signal may have time domain variation corresponding to a frequency to time transformation of a predetermined number of subcarriers, e.g., 128, each digitally modulated using a suitable technique, such as PSK, amplitude shift keying (ASK), quadrature amplitude modulation (QAM), and so forth.

The OFDM signal generated by IFFT engine 724 is converted to an analog signal by DAC 730 and applied to combiner 732. Here, DAC 730 may output an In-phase (I) analog signal Sw_I and a Quadrature phase (Q) analog signal Sw_Q in parallel. Combiner 732 may combine the analog signal with signal Sref from oscillator 704 to produce synchronization signal Sy having characteristics as described above (e.g., as in FIG. 2). To this end, as shown in FIG. 7B, combiner 732 may include: a first mixer 771 that upconverts the I signal Sw_I using Sref; a 90° delay element 774 for delaying Sref; a second mixer 772 that upconverts the Q signal Sw_Q using the 90° delayed Sref; an adder 780 that adds the upconverted I and Q signals to produce waveform Sw as a quadrature modulated signal; and a multiplexer 790 that multiplexes waveform Sw with reference signal Sref to form the synchronization signal Sy. Signal Sy is output to bandpass filter 734 and the filtered output thereof is applied to 1:N divider 104, which may equally divide Sy onto the N signal paths P_1 to P_N.

FIG. 7A further illustrates an example configuration for a single timing unit 110_1. Each timing unit 110_1 to 110_N may have the same configuration. Timing unit 110_1 may include a bandpass filter 740, a splitter 742, an analog-to-digital converter (ADC) 744, a variable delay 748, a clean-up PLL 746, a processor 750, and memory 769. Processor 750 may include a digital down converter (DDC) 752, an FFT calculator 756, a PN code decoder 758, a propagation delay calculator 759, and a time-of-day (ToD) counter 755.

Bandpass filter 740 filters the input signal Sy_1 and the filtered output signal is split by splitter 742. A first output of splitter 742 is applied to clean-up PLL 746 which may lock onto Sref, multiply Sref to generate a higher frequency tonal signal Sref′, and strip out the subcarriers. Tonal signal Sref′ has a frequency Fs=(k×Fref), where k can be an integer (e.g., two or higher) or a non-integer. Variable delay 748 may delay Sref′ by the applied delay τ_{A} received through processor 750 from the timing source 102. ADC 744 may use the delayed signal Sref′ to convert the other output signal of splitter 742 to a digital signal via sampling at the frequency Fs of Sref′. The delayed signal Sref may also be output as the output reference signal S_{RO1}.

The digital signal output from ADC 744 is digitally downconverted by DDC 752 and then applied to FFT calculator 756. FFT calculator 756 may derive complex values, each representing amplitude and phase for each of, or just some of, the subcarriers of signal Sy_1. PN code decoder 758 may decode the FFT calculator 756's output to detect whether the PN code has been detected. When the PN code is detected, propagation delay calculator 759 may use the same FFT output values associated with the PN code to calculate the propagation delay τ_{P} based on phase differences between at least one pair of subcarriers, e.g., according to eqns. (1) to (3) described above. Processor 750 may report the propagation delay τ_{P} to timing source 102 over network 140.

A reference signal output from PLL 746, i.e., Sref or Sref′, may be applied to ToD counter 755, which may increment its count with every cycle of the reference signal. As described above in connection with FIG. 5, ToD counter 755 may output a count corresponding to a local time-of-day value ToD2 at the time the synchronization signal Sy is detected. To this end, at the time that PN code decoder 758 detects the PN code was received, a process running within processor 750 may retrieve the count from ToD counter 755. Processor 750 may then report ToD2 (or just the raw count) to timing source 102. Processor 720 of timing source 102 may compute τ_{A} based on τ_{P} and ToD2 as described above and report individual values of τ_{A} to the respective timing units 110_1 to 110_N.

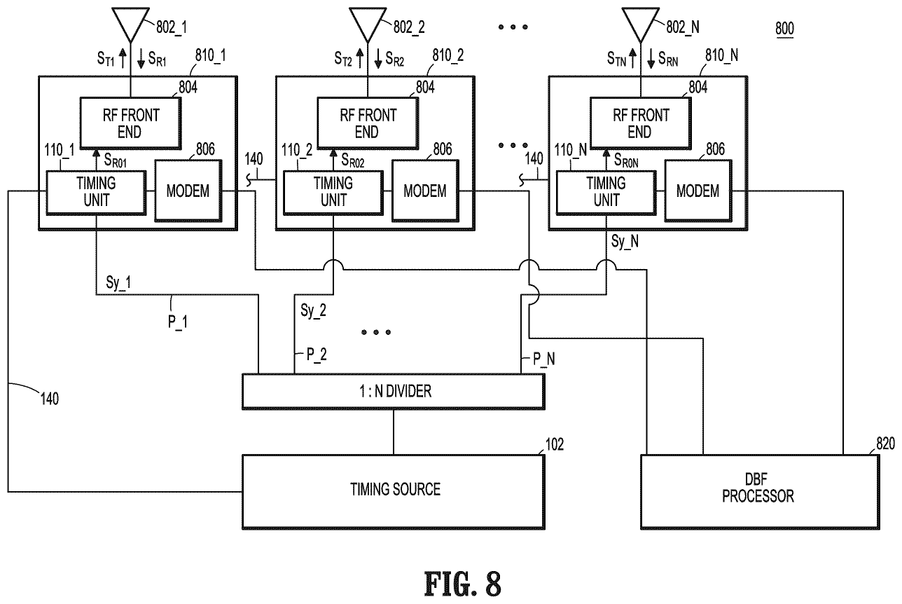

FIG. 8 schematically illustrates an example antenna system 800 that incorporates the synchronization system of FIG. 1. Antenna system 800 includes a plurality N of physically separate subassemblies 810_1 to 810_N, which are radio frequency (RF) coupled to antenna elements 802_1 to 802_N, and which include timing units 110_1 to 110_N, respectively. Antenna system 800 may further include communication network 140, timing source 102, 1: N divider 104, signal paths P_1 to P_N coupled to timing units 110_1 and 110_N as described above, and a digital beamforming (DBF) processor 820. Each subassembly 810 may further include an RF front end 804 and a modem 806. Timing source 102 and timing units 110_1 to 110_N may operate as described above to generate synchronized output reference signals S_{RO1} to S_{RON}. Antenna system 800 may be configured as a transmitting system, a receiving system, or as a transmitting and receiving system. Briefly, each of subassemblies 810 uses an output reference signal S_{RO} derived therein to generate a transmit path signal and/or receive a receive path signal in a coherent manner with other ones of the subassemblies 810. The coherent operations collectively form at least one transmit/receive beam through digital beamforming controlled by digital beamforming processor 820. Note that although each subassembly 810 is shown coupled to a single antenna element 802 as an example, each subassembly 810 may be coupled to multiple antenna elements 802 in other examples, such as to provide polarization diversity and/or to generate a plurality of simultaneous beams.

On transmit, subassemblies 810_1 to 810_N may use reference signals S_{RO1} to S_{RON} to generate and transmit coherent transmission signals S_{T1} to S_{TN} through antenna elements 802_1 to 802_N, respectively. Because signals S_{T1} to S_{TN} are coherent, antenna elements 802_1 to 802_N may operate collectively as a single antenna array to form one or more transmit beams. To this end, reference signals S_{RO} may be upconverted to coherent microwave or millimeter wave carrier signals using mixers and local oscillators within RF front ends 804. Additionally, or alternatively, reference signals S_{RO} may be used as timing signals for sampling within modems 806 to generate modulated data signals in conjunction with DBF processor 820. In either case, RF front ends 804 may each include one or more amplifiers, switches and/or one or more phase shifters to implement transmit beam steering so that antenna system 800 operates as an electronically steered or phased array antenna. Note that because antenna system 800 transmits coherent transmit signals using digital beamforming, it may omit a calibrated combiner/divider network designed for microwave/millimeter frequencies. Such a combiner/divider network is otherwise used in traditional antenna systems to divide a single RF transmit signal into N divided and phase aligned RF signals for direct routing to antenna elements 802 (with or without distributed amplification/phase shifting).

On receive, subassemblies 810_1 to 810_N may use reference signals S_{RO1} to S_{RON} to receive incoming receive signals S_{R1} to S_{RN} through antenna elements 802 in a coherent manner. To this end, reference signals S_{RO} may be used by RF front ends 804 and modems 806 as timing signals to coherently downconvert and sample receive signals S_{R1} to S_{RN}. Modems 806 may then output digital baseband receive signals to DBF processor 820 for combining, thereby forming one or more virtual receive beams. Similar to the transmit path example discussed above, RF front ends 804 may each include a mixer(s), switches, a local oscillator(s), a bandpass filter(s), low noise amplifier(s) and a phase shifter(s) to carry out the downconversion using reference signals S_{RO}, with dynamic amplification/phase shifting for receive beam steering. Because antenna system 800 receives and combines incoming receive path signals coherently using digital beamforming, it may omit a calibrated combiner/divider network designed for microwave/millimeter frequencies to otherwise obtain a combined analog receive signal.

The various illustrative logical blocks, units, engines, calculators, modules, and circuits described in connection with the present disclosure may be implemented or performed with processing circuitry within the timing source 102 and/or timing circuits 110 (e.g., processors 720 and 750) that may read and execute instructions from a non-transitory recording medium (e.g., memories 739 and 769). The processing circuitry may include a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, functions described above may be implemented using hardware, software, firmware, or any combination thereof. If implemented using software, the functions may be stored as one or more instructions or code on a non-transitory computer-readable medium (e.g., memory 739 or 769). Examples of a computer-readable medium include both computer storage media and communication media including any medium that facilitates transfer of a computer program from one place to another. A storage medium may be any available medium that can be accessed by a computer/processing circuitry.

While the technology described herein has been particularly shown and described with reference to example embodiments thereof, it will be understood by those of ordinary skill in the art that various changes in form and details may be made therein without departing from the spirit and scope of the claimed subject matter as defined by the following claims and their equivalents.

1. A synchronization method-comprising:
at a timing source:
generating a reference signal having a reference frequency;
generating a waveform including a plurality of tones;
combining the reference signal with the waveform to generate a synchronization signal having first temporal portions including the reference signal without the waveform, interspersed with second temporal portions including the waveform; and
transmitting the synchronization signal over a plurality of signal paths having different respective propagation delays to a plurality of timing circuits, respectively; and
at a first one of the timing circuits:
determining a phase difference between at least two of the plurality of tones of the waveform received thereat; and
delaying the reference signal by a delay based at least in part on the phase difference, so as to provide a first output reference signal phase aligned with a second output reference signal provided at a second one of the timing circuits.

2. The synchronization method of claim 1, further comprising:
determining, by each of the timing circuits, at least one phase difference between at least two of the plurality of tones, and a propagation delay corresponding to the at least one phase difference;
reporting, by each of the timing circuits, the propagation delay determined thereat to the timing source; and
at the timing source, receiving the propagation delay from each of the timing circuits and based at least in part thereon, determining respective delays for the timing circuits to synchronize output reference signals thereat, and transmitting the respective delays to the timing circuits.

3. The synchronization method of claim 2, wherein the reporting by each of the timing circuits to the timing source is performed over a packet network.

4. The synchronization method of claim 1, wherein the plurality of tones of the waveform are subcarriers of an orthogonal frequency division multiplexing signal.

5. The synchronization method of claim 4, wherein the subcarriers are each modulated with a pseudo-noise code.

6. The synchronization method of claim 5, wherein the subcarriers are each modulated via phase shift keying, amplitude shift keying or quadrature amplitude shift keying modulation.

7. The synchronization method of claim 4, wherein:
each of the subcarriers is spaced from at least one adjacent subcarrier by a spacing frequency of fa; and
a closest one of the subcarriers to the reference frequency is at least 2f_{Δ} away.

8. The synchronization method of claim 1, wherein the plurality of signal paths comprise at least one of Ethernet cables, optical fibers, and coaxial cables.

9. The synchronization method of claim 2, further comprising:
at the timing source, transmitting a message over a network to each of the timing circuits indicating a global time of day at which a next pulse of the waveform will be transmitted; and
at each of the timing circuits, determining a local time of day measured at a time point of detecting reception of the next pulse of the waveform, and adjusting a local clock according to a difference between the local time of day and the global time of day.

10. The synchronization method of claim 9, further comprising:
at each of the timing circuits, incrementing a count of a counter with each cycle of the received reference signal, and determining the local time of day as corresponding to the count at a time of receiving the next pulse of the waveform.

11. The synchronization method of claim 10, further comprising, at the timing source, incrementing a count of a timing source counter with each cycle of the reference signal and determining the global time of day as corresponding to the count of the timing source counter at a time of transmitting a next instance of the waveform.

12. The synchronization method of claim 9, further comprising:
at each of the timing circuits, reporting the local time of day to the timing source; and
at the timing source:
receiving respective local times of day from each of the timing circuits and based on the respective local times of day and the propagation delays; and
determining respective delays for the timing circuits to synchronize the output signals and transmitting the respective delays to the timing circuits.

13. The synchronization method of claim 10, further comprising, at each of the timing circuits, resetting the count to an initial value after the count is determined at the time of receiving the waveform.

14. The synchronization method of claim 1, further comprising:
determining, by each of the timing circuits, at least one phase difference between at least two of the plurality of tones;
reporting, by each of the timing circuits, the at least one phase difference to the timing source; and
at the timing source, receiving the at least one phase difference from each of the timing circuits and based at least in part thereon, determining respective delays for the timing circuits to synchronize output reference signals at the timing circuits, and transmitting the respective delays to the timing circuits.

15. A synchronization system comprising:
a timing source comprising:
an oscillator to generate a reference signal having a reference frequency;
one or more processors to generate a digital signal constructable from a plurality of tones;
a digital to analog converter to convert the digital signal to a waveform; and
a combiner to combine the reference signal with the waveform to generate a synchronization signal having first temporal portions including the reference signal without the waveform, interspersed with second temporal portions with the waveform;
N timing circuits, where N is at least two; and
N signal paths between the timing source and the N timing circuits, respectively, the N signal paths having different respective propagation delays;
wherein the timing source transmits the synchronization signal over the N signal paths to the N timing circuits, and a first one of the timing circuits is configured to determine a phase difference between at least two of the plurality of tones of the waveform received thereat, and to delay the reference signal by a delay based at least in part on the phase difference, so as to provide a first output reference signal phase aligned with a second output reference signal provided at a second one of the timing circuits.

16. The synchronization system of claim 15, further comprising an inverse Fast Fourier Transform engine to generate the digital signal as an orthogonal frequency division multiplexing signal representing a predetermined code.

17. The synchronization system of claim 16, wherein the predetermined code is a pseudo-noise code.

18. An antenna system comprising;
a plurality of subassemblies, each radio frequency coupled to one or more antenna elements;
a timing source comprising:
an oscillator to generate a reference signal having a reference frequency;
one or more processors to generate a digital signal constructable from a plurality of tones;
a digital to analog converter to convert the digital signal to a waveform; and
a combiner to combine the reference signal with the waveform to generate a synchronization signal having first temporal portions including the reference signal without the waveform, interspersed with second temporal portions including the waveform;
N timing circuits, each disposed within one of the subassemblies;
N signal paths between the timing source and the N timing circuits, respectively, the N signal paths having different respective propagation delays; and
a digital beamforming processor;
wherein,
the timing source transmits the synchronization signal over the N signal paths to the N timing circuits, and a first one of the timing circuits is configured to determine a phase difference between at least two of the plurality of tones of the waveform received thereat, and to delay the reference signal by a delay based at least in part on the phase difference, so as to provide a first output reference signal phase aligned with a second output reference signal provided at a second one of the timing circuits, and
each of the plurality of subassemblies uses one of the of the output reference signals to generate a transmit path signal and/or receive a receive path signal in a coherent manner with other ones of the subassemblies, to collectively form a transmit and/or receive beam through digital beamforming controlled by the digital beamforming processor.

19. The antenna system of claim 18, further comprising an inverse Fast Fourier Transform engine to generate the digital signal as an orthogonal frequency division multiplexing signal representing a predetermined code.

20. The antenna system of claim 19, wherein the predetermined code is a pseudo-noise code.
